(19) United States
(12) Patent Application Publication
(10) Pub. No.: US 2008/0310662 A1
(43) Pub. Date: Dec. 18, 2008

(54) Earpiece snoring sound transmitter

(76) Inventors: Terence M. Davidson, Poway, CA (US); Michael A. German, Salinas, CA (US)

Correspondence Address: Terence Davidson, 9500 Gilman Drive # 0617, La Jolla, CA, 92093-0617, US

(21) Appl. No.: 11/818,562

(22) Filed: Jun. 15, 2007

(51) Int. Cl. H04R 19/04

(52) U.S. Cl. 381/355

(57) ABSTRACT

The present invention is a battery-powered, Bluetooth-enabled wireless earpiece with a microphone mounted for use inside the wearer's ear canal. Its intended purpose is to transmit sounds such as snoring, generated in the user's upper airway, to a separate device for recording and/or sound analysis. In particular, the present invention is composed of a small housing that fits to all or part of the user's external ear, with a microphone that fits inside the external ear canal. An earplug sandwiched between the microphone and the housing insulates the microphone from noises generated in the outside environment. The housing of the present invention contains on the inside a rechargeable battery and Bluetooth chip, as well as necessary wiring. On its surface, the housing has an ear support piece, an on/off switch, an indicator LED, and an adaptor jack for connection to a battery charger or power cord.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

The present invention generally relates to Bluetooth headset devices and devices for monitoring or recording snoring.

2. Prior Art

Habitual snoring is a quite common problem, afflicting up to 60% of the adult male population. It can begin as an isolated phenomenon, and can then meet with disturbances and disorders of various importance, up to obstructive sleep apnea (OSA). Snoring is a respiratory sound (or noise) that is produced during sleep. It is typically an inspiratory sound, although a small expiratory component can be heard or recorded (especially in OSA patients) with different spectral features. Clinicians must distinguish it from all other sounds (noises) that can be heard, recorded and analyzed during sleep (sleep sounds syndrome, (SSS)).

Snoring produces an acoustic signal that can be described in terms of quality and quantity by means of acoustic analysis techniques. These techniques can give information on the mechanism, loudness, intensity, and sites of obstruction of the upper airway. Various analysis algorithms have been developed that allow for snoring sound interpretation. Experts such as musicians with “trained ears” have also been employed to listen to snoring sounds and interpret sound characteristics to make anatomical correlations with the patient and guide surgical decision-making.

Snoring can be a profound disturbance for the bed partner and a significant social problem that is qualifies as grounds for divorce in many states. Snoring is also a sign of pathology which can range from “of little importance”, as in light and initial forms of snoring, to “extremely important” when it occurs heavily every night and represent the premier symptom of OSA. In the setting of primary snoring without associated pathology like OSA, some patients are candidates for a variety of corrective palatal or nasal surgeries. Snoring surgery has been mainly assessed in the literature using subjective outcome measures, in particular the opinion of the bed partner. There is remarkably little published on the objective outcome following snoring surgery. One study used a portable recording device called the “Snore Box” in patients' homes and downloaded sound data for analysis. They found that patient survey data generally indicated a lower level of satisfaction than objective data would suggest. It is not clear why this difference exists.

Three main methods have been applied to analyze and measure recorded snoring sounds: 1) Leq-Equivalent Continuous Sound Level; 2) Power Spectrum (PS); and 3) Linear Prediction Code (LPC) for cross-sectional area (CSA). The details of these methods will not be elaborated here. Digital acoustical analysis of snoring has numerous advantages. Recording the snoring sound in bed, at home or in a health-care facility (in a room with low background noise) is relatively easy. This approach saves time, improves accuracy and may preempt the use of more expensive tests. The recorded signals can be sent to a sleep laboratory or analyzed “on-line”; in this way, the results can be obtained in sufficient time to help in analyzing the snoring and in determining a therapeutic approach. This method could be adopted to screen for sleep-related disorders; it is noninvasive, inexpensive, and can be easily performed in bed without qualified personnel in attendance.

Several devices have been developed which record and/or detect snoring in patients both in the clinical laboratory and in the home setting. Most devices currently in use operate via a miniature microphone, hung in front of the patient's mouth at a distance of 15-20 cm, and/or by microphones directly applied above the suprasternal notch, or on the neck or chest wall. Other devices involve the placement of a recorder in ambient proximity to the patient, such as on the nightstand in the case of the “Snore Box” mentioned above. U.S. Pat. No. 5,853,005 describes a device that uses a liquid-filled chamber to transduce sounds from the external ear canal. U.S. Pat. No. 5,989,193 describes a device used to detect ultrasonic waves generated by snoring. All of the devices heretofore known suffer from all or some of a number of limitations:

(a) In many cases, they require proper placement on the skin or at a set distance from the patient's mouth. This often involves the use of adhesive tape or glue that can be a source of discomfort for the patient.

(b) A length of wire connecting the microphone to the rest of the unit can become entangled in the bedclothes or linens causing the microphone to be disconnected or displaced during sleep.

(c) Bulky construction involving long wires or attachments may interfere with sleep or require trained technicians to set up or calibrate.

(d) Background noise such as bed partner snoring, rustling of sheets, or any noise other than the patient's own upper airway sounds is recorded on the same track, complicating interpretation.

(e) Many devices are not designed to be portable or set up for use in an uncontrolled environment such as a patient's home.

(f) The patient must physically transport stored data back to the physician for analysis, which may delay diagnosis if data is lost or corrupted.

### BACKGROUND OF INVENTION—OBJECTS AND ADVANTAGES

Accordingly, in contrast to the above mentioned disadvantages shared by prior art devices, several objects and advantages of our snoring sound recorder are:

(a) to provide a device that directly transmits snoring sound data to a center for interpretation, such as the doctor's office, a sleep center, or other facility capable of analyzing the recording;

(b) to provide a microphone that fits snugly in the external ear canal without the use of adhesive tapes or glue;

(c) to provide a method of insulating the microphone within the external ear canal through the use of an earplug to block out ambient noise as much as possible;

(d) to provide a very small, compact device that eliminates any long pieces of wire or bulky parts, is comfortable and interferes as little as possible with the patient's sleep;

(e) to provide a recording device that virtually any physician can teach any reasonably competent patient to use at home;

(f) to provide a recording device that will allow sleep surgeons to gather objective data to evaluate the outcome of snoring surgeries.

Still further objects and advantages will become apparent from a consideration of the ensuing description and drawings.

### SUMMARY

The present invention is a battery-powered, Bluetooth-enabled wireless earpiece with a microphone mounted for use inside the wearer's ear canal. Its intended purpose is to transmit sounds such as snoring, generated in the user's upper airway, to a separate device for recording and/or sound analysis. In particular, the present invention is composed of a small housing that fits to all or part of the user's external ear, with a microphone that fits inside the external ear canal. An earplug sandwiched between the microphone and the housing insulates the microphone from noises generated in the outside environment. The housing of the present invention contains on the inside a rechargeable battery and Bluetooth chip, as well as necessary wiring. On its surface, the housing has an ear support piece, an on/off switch, an indicator LED, and an adaptor jack for connection to a battery charger or power cord.

### DRAWINGS—FIGURES

FIG. 1 is a lateral view of one embodiment of the present invention.

FIG. 2 is a perspective view of one embodiment of the present invention with adaptor cord.

FIG. 3 is a schematic view of internal components comprising the present invention with adaptor cord.

FIG. 4 is a lateral view of one embodiment of the present invention superimposed over the wearer's right ear.

FIG. 5 is a perspective view of one embodiment of the present invention superimposed on a cutaway view of the wearer's right ear.

FIG. 6 is a perspective view of a second embodiment of the present invention superimposed on a cutaway view of the wearer's right ear.

### DRAWINGS—REFERENCE NUMERALS 10 housing 30 ear plug 12 ear support 32 microphone 13 radial arm 34 battery 14 cushion 36 Bluetooth chip 16 LED indicator light 38 wiring 18 on/off switch 40 external ear 20 adaptor jack 41 crest of helix 22 power cord 42 external auditory canal 24 indicator light 43 head 26 flexible connector piece. 44 eardrum 28 swivel 45 concha

### DETAILED DESCRIPTION OF THE PRESENT INVENTION

The following description is provided to enable any person skilled in the art to make and use the invention and sets forth the best modes contemplated by the inventors of carrying out their invention. Various modifications, however, will remain readily apparent to those skilled in the art, since the general principles of the present invention have been defined herein specifically to provide a Bluetooth enabled earpiece to wirelessly transmit snoring sounds measured from the external ear canal.

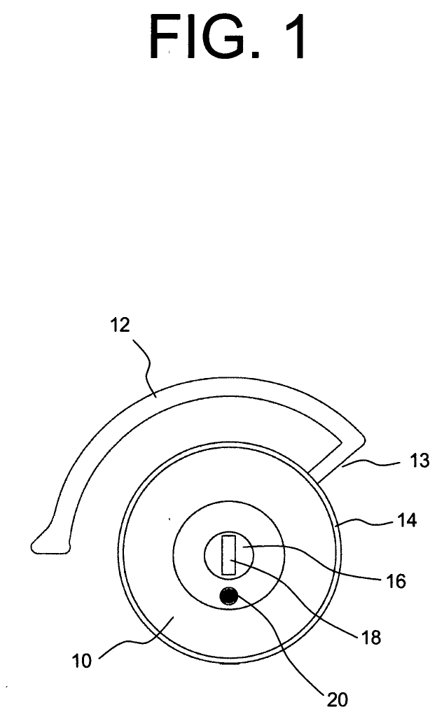

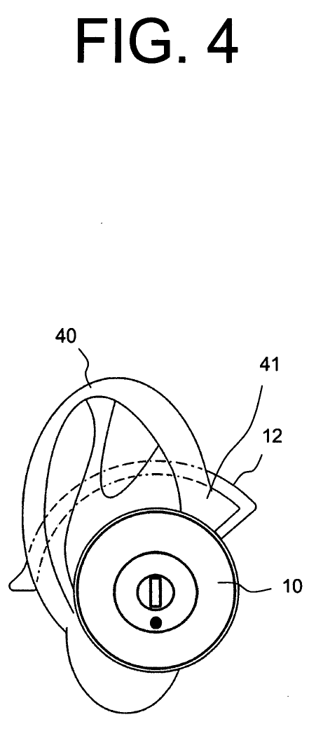

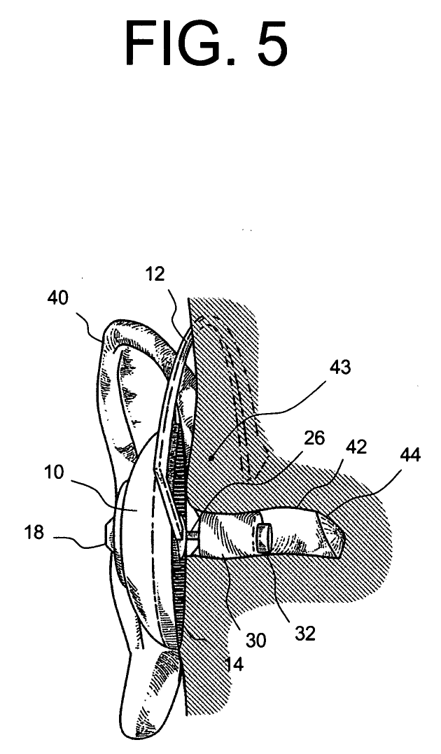

Referring now to FIG. 1, an embodiment of the present invention is shown. The invention has an ear support 12. The support 12 has a rounded arch extending from a radial arm 13. The ear support 12 is made of a flexible, soft molded polyvinyl chloride (PVC) material. Alternately, the ear support can be made of foam rubber or hard plastic, e.g. high impact polystyrene (HIPS) and/or acrylonitrile butadiene styrene (ABS). This embodiment of the ear support 12 is suited for wearing by a user behind the crest of the user's helix 41, fixing it to the outer ear 40 as shown in FIGS. 4 and 5. The ear support 12 may be fixed or adjustable, permanent or removable.

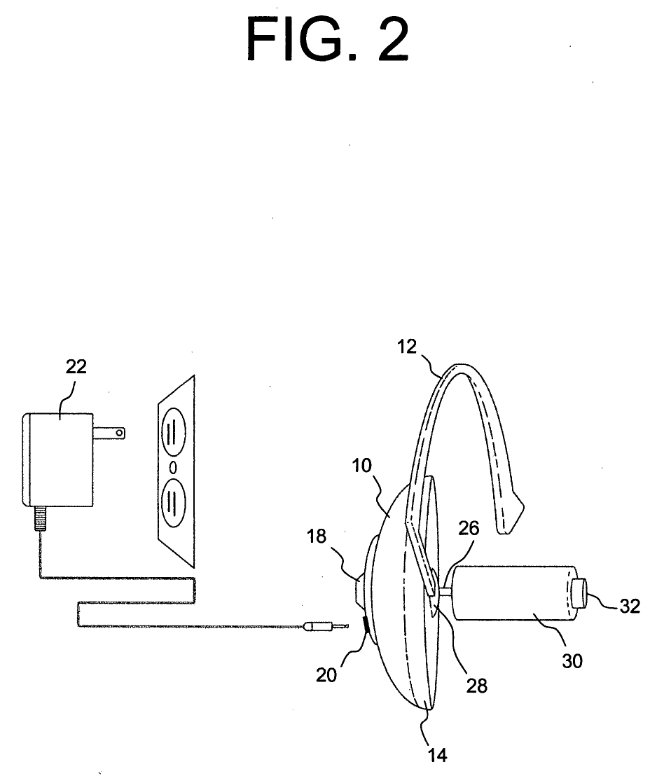

The radial arm 13 is attached to the housing 10 by a swivel mechanism 28, shown in FIG. 2, that allows the ear support 12 to rotate around the axis of the housing 10. When the user wears the present invention, the radial arm 13 is positioned between the housing 10 and the user's head 43 as shown in FIG. 5. The construction of the ear support 12 is such that it can be adapted for use on either the left or right ear.

The housing 10 is made of acrylonitrile butadiene styrene (ABS), or a similar thermoplastic commonly used to make lightweight, rigid, molded products. The housing 10 is shaped to conform to all or part of the external ear 40 of the wearer, or in an alternative embodiment, may be shaped so as to be confined entirely within the wearer's external auditory canal 42. At the base of the housing 10 is a cushion 14 made of silicone, PVC, foam rubber, or other soft, lightweight moldable material that abuts the user's external ear 40, and possibly the user's head 43 as well, as shown in FIG. 5.

Referring to the lateral view of the present invention depicted in FIG. 1, there are several exterior features of the housing 10. An on/off switch 18 is depicted. In proximity to the on/off switch is an LED indicator light 16 that lights up for several seconds when the on/off switch 18 is placed in the “on” position and sufficient battery power remains or the power cord 22 is attached. The light 16 may flash or change to a different color when battery power is critically low. As shown in FIGS. 1 and 2, the housing also has an adaptor jack 20 to charge the battery 34 with a power cord 22, or to power the unit directly.

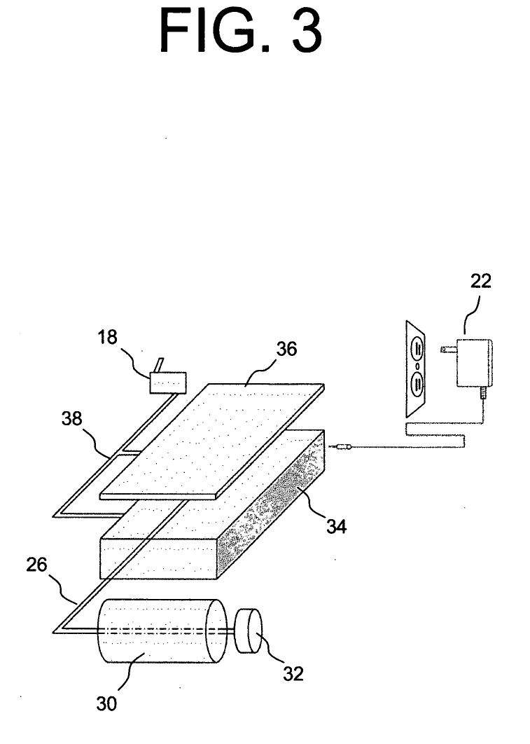

Referring to the perspective view of the present invention depicted in FIG. 2, and to the schematic of internal parts depicted in FIG. 3, the surface that sits proximal to the user's head 43 supports a flexible connector piece 26 that attaches to and penetrates completely through the central axis of an earplug 30. The connector piece 26 is made of plastic or rubber tubing and functions as a conduit that encases wiring 38 and connects the Bluetooth chip 36 with the microphone 32. The earplug 30 is like standard earplugs that are made of visco-elastic polyurethane foam (memory foam). The connecter piece 26 may be removed from the housing 10 to replace a used earplug 30 with a new one. The microphone is a tiny (6 mm or less) omni-directional type, currently available from many vendors.

The Bluetooth chip 36 depicted in FIG. 3 is powered by a rechargeable battery 34, lithium polymer or similar type. The Bluetooth chip 36, the battery 34, and the wiring 38 are contained inside the housing 10. The battery 34 is wired to the switch 18 through wiring 38. The construction of the internal elements is similar to that of existing Bluetooth earpieces that are presently commercially available. Unlike such Bluetooth earpieces, however, the present invention eliminates a speaker element.

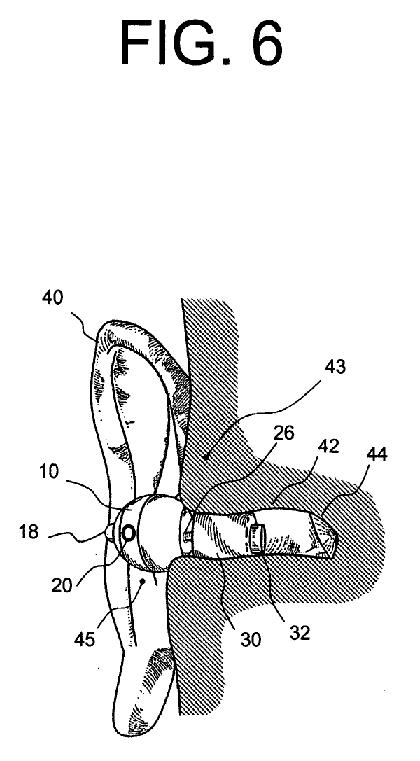

In another embodiment, as shown in FIG. 6, the present invention is confined to the external auditory canal 42 and concha 45, without an associated ear support 12. The fundamental elements of the present invention are the same, with an earplug 30 sealing the external ear canal and insulating a microphone 32 from ambient noise. Distal to the earplug 30 is the housing 10 comprising on its surface an on/off switch 18, and indicator LED 16, and an adaptor jack 20. Internal components are likewise the same, comprising a Bluetooth chip 36, a battery 34, and wiring 38.

### Operation—Possible Embodiments—FIGS. 5 and 6

FIG. 5 shows one embodiment of the present invention in use. The earplug 30 is compressed between the user's fingers in the customary manner of preparing common earplugs for placement. The compressed earplug 30 is then inserted into the external auditory canal 42 where it expands to conform to the canal 42 and create a seal. This seal insulates the microphone 32 from noises external to the user and only allows for transmission of noises generated by the user.

The ear support 12 is fitted over the user's ear 40 and the cushion 14 sits against the user's head 43. The microphone 32 is positioned between the earplug 30 and the eardrum 44 to register sounds transmitted from the user's upper airway. When the switch 18 is turned “on,” the present invention can be paired with a peripheral device across a piconet, the fundamental network set up between Bluetooth-enabled devices. Pairing the devices is very simple with version 2.1+EDR, and virtually any doctor or patient would be able to do so.

FIG. 6 shows a second embodiment of the present invention in use. The use of this embodiment is similar to that described above for the embodiment depicted in FIG. 5 with the exception of the ear support 12, not present in the current embodiment.

Sound data is sent by the Bluetooth chip 36 over the unlicensed ISM band at 2.4 GHz to a peripheral device. This device can be a cellular phone, computer, or other Bluetooth-enabled device that is capable of receiving and recording sound for analysis. In the case of a cellular phone, the user could call a dedicated phone number and create a recorded message of snoring sounds overnight. The record could then be analyzed remotely and be available to the physician for interpretation shortly thereafter. Bluetooth technology is ideal for transmitting both sound information, especially voice, as well as data. This makes it ideal for inclusion in the present invention.

Thus, an earpiece snoring sound transmitter is described above that is Bluetooth enabled, not cumbersome, has a compact power source and is easy to use by virtually any patient. In each of the above embodiments, the different positions and structures of the present invention are described separately. However, it is the full intention of the inventor of the present invention that the separate aspects of each embodiment described herein may be combined with the other embodiments described herein. Those skilled in the art will appreciate that adaptations and modifications of the just-described embodiments can be configured without departing from the scope and spirit of the invention. Therefore, it is to be understood that, within the scope of the appended claims, the invention may be practiced other than as specifically described herein.

What is claimed is:

1. An earpiece snoring sound transmitter for a user producing upper airway sounds and having an external ear with a crest of helix and an external auditory canal, the earpiece snoring sound transmitter comprising:
a) an ear support for placement behind the crest of helix, attached to a housing made of a rigid, moldable or shapeable material,
b) said housing containing a battery, and means for electronically transmitting the upper airway sounds or the absence of such sounds,
c) means for joining the battery with said means for electronically transmitting the upper airway sounds or the absence of such sounds,
d) a microphone small enough to fit in the external auditory canal and an earplug sandwiched between the microphone and the housing,
e) whereby said earplug insulates said microphone from noise other than said upper airway sounds.

2. The earpiece snoring sound transmitter of claim 1 wherein said housing comprises an indicator LED.

3. The earpiece snoring sound transmitter of claim 2 wherein said housing further comprises an on/off switch.

4. The earpiece snoring sound transmitter of claim 3 wherein said housing further comprises a cushion.

5. The earpiece snoring sound transmitter of claim 4 wherein said housing is made of acrylonitrile butadiene styrene, high-impact polystyrene, or polyvinyl chloride.

6. The earpiece snoring sound transmitter of claim 1 wherein the means for transmitting said upper airway sounds is a bluetooth chip.

7. The earpiece snoring sound transmitter of claim 1 wherein said battery is rechargeable.

8. The earpiece snoring sound transmitter of claim 1 wherein said ear support is pivotally attached to said housing.

9. A method of transmitting upper airway sounds or the absence of such sounds from a user having an upper airway and an external ear with a crest of helix and an external auditory canal comprising:
a) Providing an earpiece of the type comprising an earplug sandwiched between a microphone and a housing made of rigid, moldable or shapeable material wherein said housing comprises a battery and a bluetooth chip.
b) Providing a means of electrically coupling said battery to said bluetooth chip.
c) Providing a means of electrically coupling said bluetooth chip to said microphone.
d) Inserting said earplug and said microphone into said user's external auditory canal to create a seal.
e) Whereby said microphone registers only sounds generated in said user's upper airway.
f) Whereby said sounds are transmitted by said bluetooth chip.

10. The method of claim 9 wherein said housing is made of acrylonitrile butadiene styrene, high-impact polystyrene, or polyvinyl chloride.

11. The method of claim 9 wherein said housing comprises an ear support pivotally attached to said housing.

12. The method of claim 11 wherein said ear support is wearable around said crest of helix.

13. The method of claim 9 wherein said battery is rechargeable.
